(19) United States
(12) Patent Application Publication
(10) Pub. No.: US 2019/0005492 A1
(43) Pub. Date: Jan. 3, 2019

(54) SELF-CORRECTING TRANSACTIONS

(71) Applicant: PAYPAL, INC., San Jose, CA (US)

(72) Inventors: Lokesh Subramanya, Morgan Hill, CA (US); Krishnakumar Balasubramanian, San Jose, CA (US); Tim Craig, San Jose, CA (US)

(21) Appl. No.: 15/636,322

(22) Filed: Jun. 28, 2017

(51) Int. Cl. G06Q 20/38; G06F 11/14

(52) U.S. Cl. CPC G06Q 20/389; G06Q 20/405; G06F 11/1474

(57) ABSTRACT

Aspects of the present disclosure involve a system and method for journaling transactions and identifying and correcting transaction errors. In one embodiment, a system is introduced that includes isolated clusters that are capable of journaling the state of a transaction after every critical step. In another embodiment, the system is introduced that can sweep the journaled transactions in order to identify post-processing transactional errors. Still in another embodiment, a system is introduced that is capable of performing a self-correcting mechanism that enables error correction in the background without presenting a failed notification to a customer.

### TECHNICAL FIELD

The present disclosure generally relates to communication devices for transaction journaling, and more specifically, to communication devices that provide self-correcting transactions.

### BACKGROUND

In the advent of technology, industry has moved to the use of electronic devices and communications for processing transactions. The transactions can generally begin with a consumer submitting a funding instrument for payment and continues to a vendor for authorization of such transaction. The vendor receives the request and responds with an authorization. Upon receipt of authorization post-processing takes place which upon completion presents the consumer with an approved transaction notice. However, in some instances, post processing can encounter technical failures that may present a consumer with a failed transaction notice even after the vendor has responded with an authorization. This failure can often cause frustration and can lead to an unsatisfactory consumer experience. Therefore, it would be beneficial to create a system that provides a successful notification while performing transaction self-correction in the background without customer knowledge.

### BRIEF DESCRIPTION OF THE FIGURES

FIG. 1 illustrates systems for transaction state management.

FIG. 2 illustrates a timing diagram of a communication between systems for transaction sweeping.

FIG. 3 illustrates a timing diagram of a communication between systems for transaction correction sweeping.

FIG. 4 illustrates a flow diagram illustrating operations for performing transaction sweeping and transaction failure detection.

FIGS. 5A-5B illustrate flow diagrams illustrating operations for performing transaction failure correction.

FIG. 6 illustrates a block diagram of a system for performing self-correcting transactions.

FIG. 7 illustrates an example block diagram of a computer system suitable for implementing one or more devices of the communication systems of FIGS. 1-6.

Embodiments of the present disclosure and their advantages are best understood by referring to the detailed description that follows. It should be appreciated that like reference numerals are used to identify like elements illustrated in one or more of the figures, whereas showings therein are for purposes of illustrating embodiments of the present disclosure and not for purposes of limiting the same.

### DETAILED DESCRIPTION

In the following description, specific details are set forth describing some embodiments consistent with the present disclosure. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Aspects of the present disclosure involve systems, methods, devices, and the like for journaling transactions and identifying and correcting transaction errors. In one embodiment, a system is introduced that includes isolated clusters that are capable of journaling the state of a transaction after every critical step. In another embodiment, the system is introduced that can sweep the journaled transactions in order to identify post-processing transactional errors. Still in another embodiment, a system is introduced that is capable of performing a self-correcting mechanism that enables error correction in the background without presenting a failed notification to a customer.

Conventionally, post-processing systems designed for processing and transaction journaling have been designed to operate over a distributed network of servers located at various remote locations. Transactions being processed can therefore end up recorded a numerous servers during the different stages of the processing. Thus, if an error occurs during the transaction processing, the transaction may need to be traced back to multiple servers that are sparsely located.

It is therefore beneficial to have a centralized system where the transactions are isolated to a single location and the datacenters are designed to work in clusters. A cluster can be a system where two or more servers work together for the storage and processing of information. The clusters can function to distribute workloads to each of the servers, manage the transfer of workloads between servers and provide access to files. Therefore, providing a system that works from a centralized location without the need to traceback to multiple locations can provide an increase in performance, capacity and increase in reliability over distribute networks.

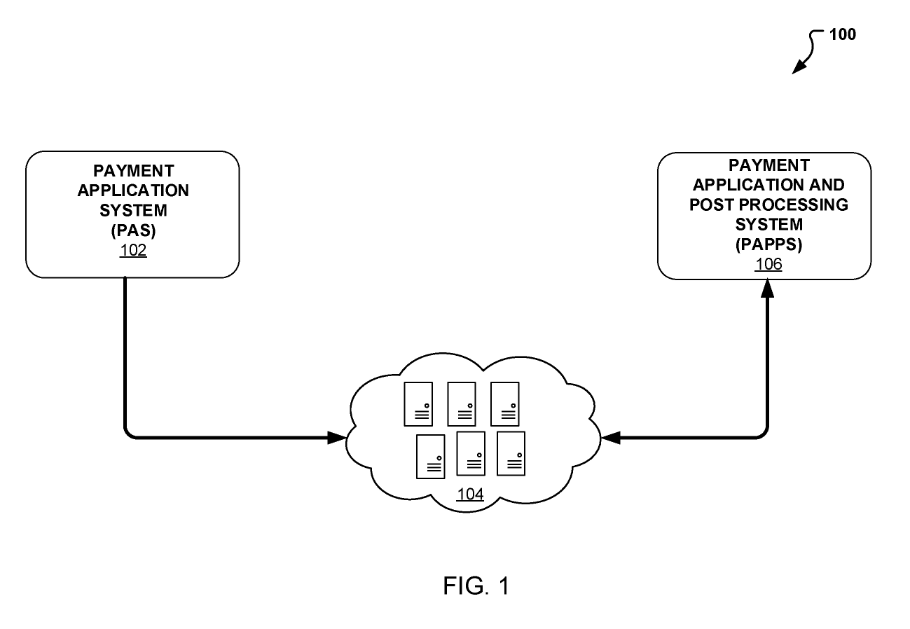

FIG. 1 illustrates systems for transaction state management. In particular, FIG. 1 illustrates a system 100 that can record transactions and cleanup any inconsistencies/failures found in the transactions by applying corrective actions. The system 100 can include a Payment Application System (PAS) 102, a journaling system 104, and a Payment Application and Post Processing System (PAPPS) 106. The PAS 102 can be a system designed to handle the business logic portion of the transaction. For example, the PAS can handle transaction authorization and can capture the financial instruments supported by the system. The authorization and capture by the PAS 102 can be performed during, before, or after a payment transaction. In one embodiment, the authorization and capture can occur during the payment transaction, in real-time. During the payment transaction, the PAS 102 can communicate directly with journaling system 104.

Journaling system 104 can be a state management journaling system used to record transactions received by the PAS 102. As indicated, conventionally journaling centers have been designed to have a single database system that is distributed across multiple datacenters. In the present embodiment, journaling system 104 is introduced such that an isolated cluster for transaction management is deployed in each data center. By introducing an isolated cluster at each datacenter, a transaction can be recorded and tracked in its entirety in a single location. Therefore, if a transactional error needs to be traced back or any transactional information needs to be retrieved, a record of the transaction can be obtained at a single location. Again, this being advantageous over conventional systems where any failure encountered or information retrieval would necessitate a rerouting through the multiple datacenters in order to track. The isolated cluster can also allow for improved organization, processing, and transaction sweeping as the information in centrally located. For example, system 100 can devote a datacenter to a group of transactions and thus is able to perform a sweep of the transactions and if an error occurs detect the failure in that corresponding datacenter.

As transactions are journaled/recorded in journaling system 104, payment application system (PAPPS) 106 sweeps the transactions for errors. In other words, journaling system 104 is in communication with PAPPS 106, which reads the journals for post-processing.

As indicated, upon submission of a transaction, the transactional information is sent to vendors (e.g., Visa, MasterCard) for authorization. Upon receipt of authorization, a payment processing system like PAS 102 submits the transaction for settlement. If the transaction failed, PAS 102 will return a success notification to the user such that the journaling system will self-correct. Upon returning the notification, PAPPS 106 will sweep the journaling system 104 and ensure the transaction data was properly settled and/or recorded. If PAPPS 106 determines that a settlement submission failed, it will carry out the processing to correct the settlement including the re-submission of the transaction for settlement.

To ensure proper recordation and settlement of transaction data, system 100 collaboratively journals the state of each transaction after every critical step in the processing. By journaling the state of the transaction after every critical step, a record of each transaction can be maintained which enables tracking of all transactions as well as its state at every critical step in the transaction. In addition, by journaling at every critical step in the transaction, the journal can be maintained such that if a failure occurs (e.g., in settlement, in transaction recordation, system crashes, etc. the location where the failure occurred can be determined, corrected, and the transaction can be recovered.

Once the transactions are journaled, the PAPPS 106 system can run sweeps to ensure that the journaled transactions are in a consistent state. In some embodiments, the PAPPS 106 can run continuously such that the transactions are constantly monitored. In other embodiments, the PAPPS 106 can run at varying time intervals, which can be dynamically determined, based on the number of transactions in the queue. In the current embodiment, the PAPPS 106 can sweep transactions periodically, at predetermined time intervals (e.g., every hour).

During the PAPPS 106 run, the PAPPS 106 can sweep through the journals to determine if any of the transactions swept have resulted in a failure. For example, the PAPPS 106 system can detect if any of the transactions have resulted in a settlement or record to database failure. If the PAPPS 106 system identifies a failure, it can attempt to correct the failure by re-trying to settle and/or record to the database in the background until the particular task is completed.

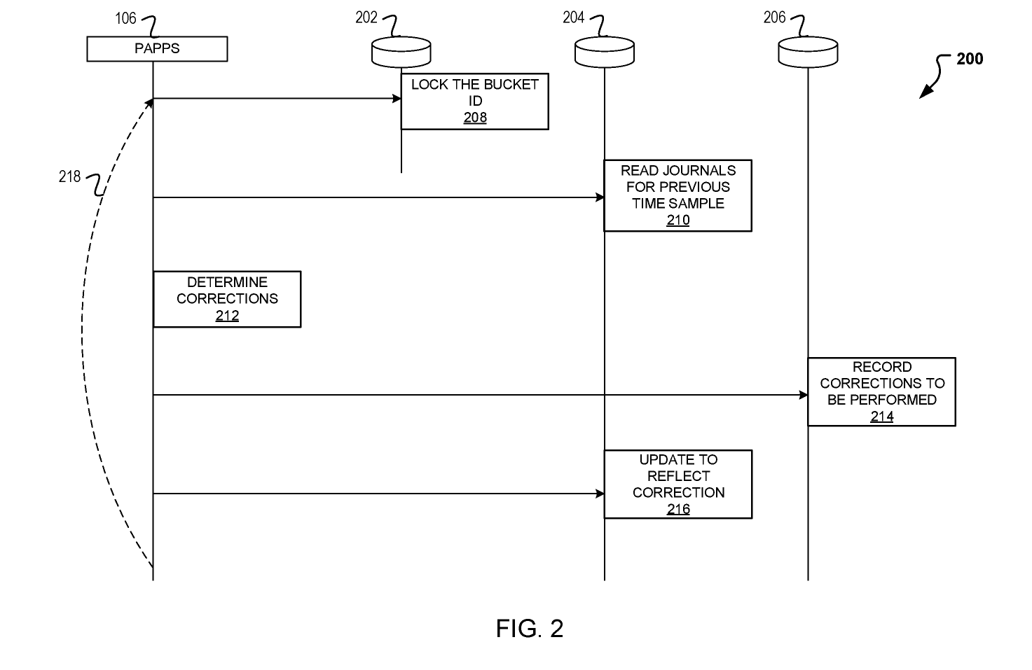

To exemplify how transactions are swept, FIG. 2 is provided to illustrate an exemplary timing diagram 200 of a communication between systems for transaction sweeping. In particular, FIG. 2 illustrates the timing diagram 200 of the steps or actions that take place in PAPPS 106 system to ensure post-processing failures are detected and corrected. The timing diagram 200 begins with the PAPPS 106 system which performs the sweeping operation of the journaled transactions. To ensure a race condition does not occur, or that during the post-processing the transactions do not overlap, the transactions are evaluated and categorized using a journal execution log (or journaling sub-system) 202. In other words, the journal execution log 202 is used to safeguard against the transaction being picked up by two nodes. Fundamentally, the journal execution log 202, can function as a table that is used to designate journal transactions to a category or “bucket ID.” Each transaction is designated a bucket ID such that once the transaction has been categorized into a bucket (in a corresponding node), another node cannot pick it up. Therefore, the PAPPS 106 can perform a sweep on a bucket-by-bucket basis such that transactions are sweeped based on their bucket ID.

An example of how the bucket ID is used for sweeping, consider the use of two nodes in a PAPPS 106 system performing a sweep in one data center (corresponding table below): The process can include: 1) Node 1 and Node 2 begin at the same time. 2) Node 1 locks bucket 1 and sweeps all transactions in bucket 1. Each transaction is swept for failure detection and routed to a correction queue in the instance that an error is detected. 3) Node 2 locks bucket 2 since bucket 1 has been previously locked and continues to sweep all transactions under bucket 2. Again, any transactions detected are routed to a correction queue. 4) As Node 1 completes bucket 1, it continues to sweep bucket 3 and Node 2 continues to bucket 4 as bucket 2 is completed. 5) sweeping continues by both nodes until all transactions are swept in all buckets. Once this is completed, Nodes 1 and 2 sleep and wait until a next scheduled time for a sweep.

| TRANSACTION ID | BUCKET ID |
|---|---|
| 101 | 1 |
| 102 | 1 |
| 103 | 1 |
| 201 | 2 |
| 202 | 2 |
| 203 | 2 |
| 301 | 3 |
| 302 | 3 |
| 303 | 3 |
| 401 | 4 |

Note that the bucket IDs can be dynamically determined, pre-defined, and in some instances determined based on a maximum range and locked 208. Thus, any transaction that is processed will fall into one of the buckets. The corresponding bucket (bucket ID) can be designated using a first-in first-out (FIFO) method, last-in first-out (LIFO method), or using a weighted method. In a current embodiment, the bucket ID can be designated based on the transaction ID.

Once the transactions have been categorized into buckets, the PAPPS 106 can sweep the bucket. As illustrated in timing diagram 200, the sweep can be performed by transaction journal (or transaction journaling sub-system) 204 and the transaction journal 204 can read/sweep the transactions in the from a previous time sample 210. For example, if 100 buckets have been designated by the journal execution log 202, transaction journal 204 can select and sweep a particular bucket (e.g., bucket 50) from the 100 buckets identified. In addition, the transaction journal sweeps those transactions in the bucket during a previous time sample (e.g., the previous hour, t−1).

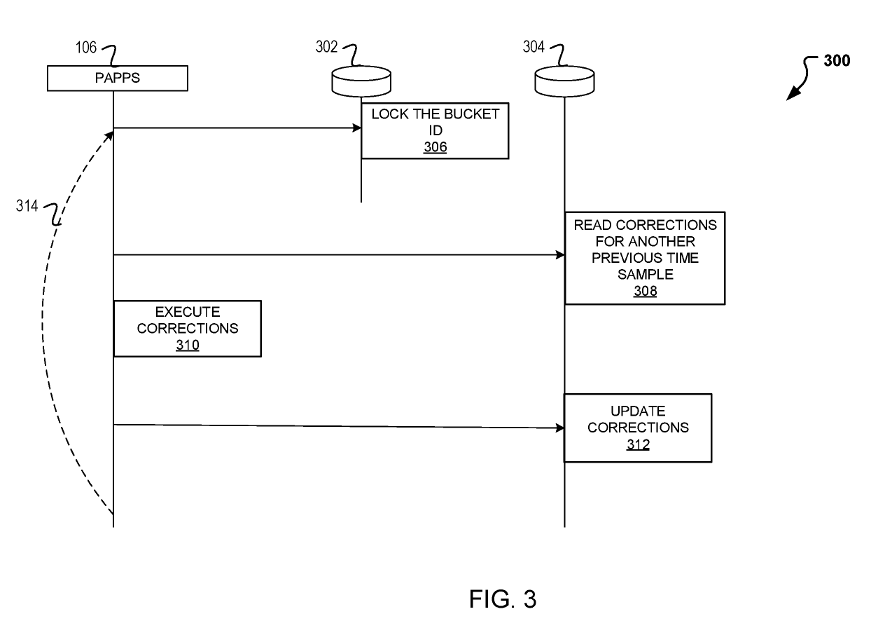

During the bucket sweeping, the post-processing server PAPPS 106 can determine if any of the transactions processed includes a failure and needs to be corrected 212. If a transaction is identified that needs to be corrected, then the transaction ID or details regarding the failed transaction are recorded in correction journal (or correction journaling sub-system) 206 so that corrections that need to be performed are recorded 214. Simultaneously, the transaction journal table 204 may be updated with a designation or information corresponding to those transactions that have been swept and going to the correction journal table 206. At the correction journal table, the transactions identified are corrected and the transaction journal 204 is updated to reflect the corrections 216. Once all transactions in the bucket have been read, the process moves forward with the next bucket 218. Further details regarding the corrections performed are described in more detail below and in conjunction with FIG. 3.

Note that in some instances, the post-processing steps can work asynchronously such that upon recording the transaction IDs corresponding to failed transaction in correction journal 206, the next transaction can be swept. Thus, any corrections not completed may continue to be retried in the background and the transaction journal can be updated to reflect those corrections achieved. Alternatively, the transactions that haven't been processed for correction or are still failing may be placed into a subset database for handling.

Simultaneously, another post-processing server can also sweep transactions with a different bucket ID (e.g., transactions designated to bucket ID 25). Therefore, sweeping process may entail the use of multiple servers and enables sweeping consecutive buckets until all buckets have been swept. This can occur in a round robin fashion so that as the sweeping of one bucket is completed, the processing server (e.g., PAPPS 106) can move to the next bucket that is still available.

As indicated transactions in need of correction are flagged and processed for correction. FIG. 3 illustrates a timing diagram 300 of a communication between systems for transaction correction sweeping. As previously indicated, the PAPPS 106 sweeps transactions processed and uses the journal execution log 302 to categorize the transactions into buckets. Bucket designation of the transactions enables the sweeping of transactions on a bucket-by-bucket basis such that a transaction is not processed multiple times. In some instances, the transaction correction sweep can commence at the PAPPS 106 where those transactions in need of correction are identified (e.g. determine corrections 212 in FIG. 2). The transactions identified for correction can then be classified into corresponding buckets based on a transaction identifier (e.g., transaction ID, transaction type, transaction time, node ID, etc.). The number of buckets to be used and bucket ID can be locked 208 such that, the transactions considered in the journal execution log 302, fall within a given bucket ID from a range x. The locked 208 bucket ID is reconfigurable. In other instances, the entire bucket range is locked such that a given number of buckets is used. As similarly done during the transaction sweeping, performing the transaction correction sweep entails the journal execution log 302 categorizing those transactions designated for correction to enable the sweeping of the transactions for correction on a bucket-by-bucket basis by locking bucket ID 306.

Once the transactions for correction are categorized, correction sweeping continues to the correction journal table 304 where correction sweeping occurs. Note that unlike the FIG. 2, where the transaction journal 204 is used for journal sweeping, in correction sweeping, correction journal 304 is used and read to identify previously flagged transactions for correction. In particular, at the correction journal 304, the transactions identified for correction from a previous time sample are read 308. For example, if journal sweeping is occurring every hour, then correction sweeping can occur every two hours such that those transactions identified for correction during the previous hour are swept the following hour. In one embodiment, journal sweeping can occur at previous time sample n−1 while correction sweeping occurs at every n−2 time interval. In another example, the journal sweeping and the correction sweeping can occur every hour. In a current embodiment, journals sweeping can occur at previous time sample n−1 and correction sweeping can also occur at a previous time interval n−1. Thus, the transaction sweeping is triggered every hour and once transaction sweeping is complete it triggers the correction sweeping process.

Note that correction sweeping is not limited to sweeping on an interval basis. In some embodiments, correction sweeping can occur in a continuous manner such that a correction sweep is continuously occurring. Still in other embodiments, correction sweeping can occur in conjunction with the use of secondary table or subset table. The subset table can include a flag which identifies the completion of a bucket and at that moment correction sweeping can begin. Alternatively or additionally, a subset table can be used to identify transactions that may need additional sweeping and so that those transactions can be swept again.

Once the transactions have been identified, the transactions can be executed for correction 310 by the PAPPS 106. Note that in one embodiment, transaction failures can occur during the post-processing of a transaction. In this embodiment, the failure can occur if a transaction is not recorded or if a failure at settlement is detected. As a result, executing corrections 310 can include calling settlement to correct the failure or recording the data into the system. Note that the failures included are for exemplary purposes and other failures and corrections are possible.

In performing corrections, PAPPS 106 can attempt to correct the error, a designated n amount of times. For example, correction sweeping can attempt correction n=3 times. The attempts can repeat until the failure is corrected and the transaction status is move to a success state 312 in the correction journal 304. If the failure continues, the system can try again on the next correction sweep, table the correction for a later attempt, or provide a notification to a service provider for manual correction. For example, a user interface at the service provider can a visual representation of the transaction error with the journal information regarding the failure. In addition, the user interface can provide statistical information regarding current transactions, transactions in failure, transactions retried for correction, transactions with sustaining failures, and the like.

Once the status of the transactions for correction have been updated in the correction journal 312, and the current bucket has been completely executed, the process is repeated until the last bucket is reached 314. Alternatively, transaction correction can occur and continue concurrently during the correction sweeping and correction execution of another bucket.

Note that various other implementations of data journaling, transaction sweeping, and correction sweeping may be contemplated. FIGS. 2 and 3 illustrates but exemplary timing diagrams 200,300 respectively, of transaction post-processing for simplicity.

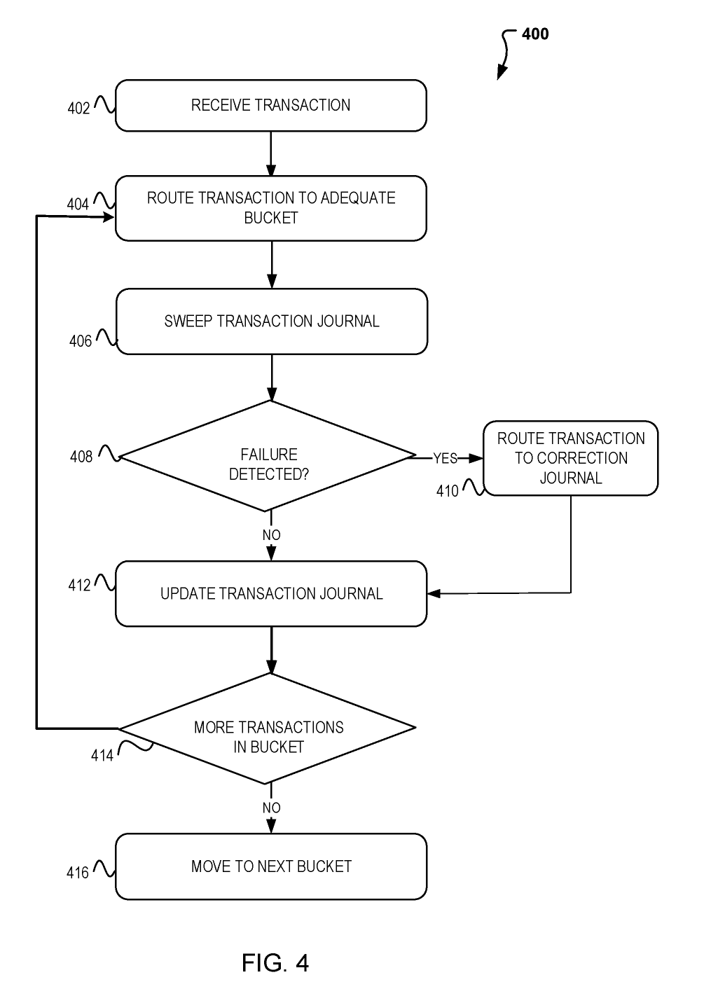

FIG. 4 illustrates example process 400 for transaction sweeping that may be implemented by a system such as system 100 of FIG. 1 and/or timing diagram 200 of FIG. 2. In particular, FIG. 4 illustrates a flow diagram illustrating operations for transaction sweeping in a PAPPS 106 system. According to some embodiments, process 400 may include one or more of operations 402-416, which may be implemented, at least in part, in the form of executable code stored on a non-transitory, tangible, machine readable media that, when run on one or more hardware processors, may cause a system to perform one or more of the operations 402-416.

Process 400 may begin with operation 402, where vendor authorization has been received for a purchase transaction and now available for post-processing. Post-processing of the authorized purchase transaction can occur in PAPPS 106. As indicated, the PAPPS 106 is a post-processing system that can be used to submit the transactions for settlement and ensure that the transaction data is properly recorded in journaling system 104. In addition, PAPPS 106 is a system that can be used to sweep the transactions to further ensure that transaction failures are detected and corrected.

Once the transactions have been received, process 400 continues to operation 404, where transaction sweeping begins and a scheduler can sweep transactions on a timed interval and the transactions are routed to an adequate bucket. It one embodiment, the scheduler can run once every hour. In other embodiments, the time interval is configurable. To safeguard against duplicate transaction sweeping, a system has been designed where the transactions are categorized into one of a group of buckets based on the transaction ID or other identifying information corresponding to the current transaction. The number of buckets, bucket IDs and other categorizing information can be pre-defined or dynamically determined based in part on the number of transactions and/or buckets available. The buckets can then be run independently and transactions can be swept for errors/failures. During operation 404, a bucket ID may by selected from a range of available buckets and the corresponding bucket ID can be locked.

In operation 406, the transaction journal is swept for the selected bucket ID. Sweeping the transaction journal can entail reading all transactions in the journal and checking for failures. Alternatively, a selected number of transactions can be swept and/or a number of transactions can be swept that fall within a given time period. The time period can be pre-defined or dynamically determined based on the status of the processing operations, number of transactions, or the like.

As indicated, the transaction journal is swept on a bucket-by-bucket basis to avoid duplicating the transaction read. Therefore, in operation 406 of process 400, a first bucket can be swept and in operation 408 a determination is made as to whether a failure has been detected on the current transaction. If a failure exists, process 400 continues to operation 410 where the transaction identified for correction is routed for journaling to the correction journal. Thus, any transactions in need of corrections are recorded at this operation. Upon correction of the failure, the transaction is routed back to the transaction journal where the journal is updated to indicate that the failure has been corrected. In instances where no failure is detected at operation 408, process 400 continues to operation 412 where the transaction journal includes a successful indication. However, in some instances, a successful transaction may not be updated unless a failure was detected.

This process can continue until the entire bucket has been swept. Therefore, if more transactions remain in the bucket during operation 414, then the remaining transaction(s) are swept in operation 404. If, no transactions remain in the current bucket, process 400 continues to operation 416 where journal sweeping continues to the next bucket until all buckets and/or transactions have been swept. Once completed, the scheduler can wait for the next scheduled sweep.

Note that although process 400 is discussed on a transaction-by-transaction basis, the entire transaction journal may be swept before failures are routed to the correction journal. In some instances, a group of transactions may be routed at given time intervals. Still in other instances, all transactions failures in one or more buckets can be routed to the correction journal simultaneously. In addition, multiple buckets can be swept simultaneously be a separate post-processing system (e.g., PAPPS) existent within the same node/cluster.

FIG. 4 illustrates example process 400 for transaction sweeping that may be implemented by a system such as system 100 of FIG. 1 and/or timing diagram 200 of FIG. 2. In particular, FIG. 4 illustrates a flow diagram illustrating operations for transaction sweeping in a PAPPS system. According to some embodiments, process 400 may include one or more of operations 402-416, which may be implemented, at least in part, in the form of executable code stored on a non-transitory, tangible, machine readable media that, when run on one or more hardware processors, may cause a system to perform one or more of the operations 402-416.

Process 400 may begin with operation 402, where vendor authorization has been received for a purchase transaction and now available for post-processing. Post-processing of the authorized purchase transaction can occur in PAPPS. As indicated, the PAPPS is a post-processing system that can be used to submit the transactions for settlement and ensure that the transaction data is properly recorded in journaling system 104. In addition, PAPPS is a system that can be used to sweep the transactions to further ensure that transaction failures are detected and corrected.

Once the transactions have been received, process 400 continues to operation 404, where transaction sweeping begins and the transactions are routed to an adequate bucket. To safeguard against duplicate transaction sweeping, a system has been designed categorized the transactions into one of a group of buckets based on the transaction ID and/or other identifying information corresponding to the current transaction. The number of buckets, bucket IDs and other categorizing information can be pre-defined or dynamically determined based in part on the number of transactions and/or buckets available. The buckets can then be run independently and transactions can be swept for errors/failures.

In operation 406, the transaction journal is swept. Sweeping the transaction journal can entail reading all transactions in the journal and checking for failures. Alternatively, a selected number of transactions can be swept and/or a number of transactions can be swept that fall within a given time period. The time period can be pre-defined or dynamically determined based on the status of the processing operations, number of transactions, or the like.

As indicated, the transaction journal is swept on a bucket-by-bucket basis to avoid duplicating the transaction read. Therefore, in operation 406 of process 400, a first bucket can be swept and in operation 408 a determination is made as to whether a failure has been detected on the current transaction. If a failure exists, process 400 continues to operation 410 where the transaction identified for correction is routed for journaling to the correction journal. Thus, any transactions in need of corrections are recorded at this operation. Upon correction of the failure, the transaction is routed back to the transaction journal where the journal is updated to indicate that the failure has been corrected. Alternatively, upon correction of the failure, an indication can be transmitted to the transaction journal to update the corrected transaction record. In instances where no failure is detected at operation 408, process 400 continues to operation 412 where the transaction journal includes a successful indication. However, in some instances, a successful transaction may not be or need to be updated unless a failure was detected.

This process can continue until the entire bucket has been swept. Therefore, if more transactions remain in the bucket during operation 414, then the remain transaction(s) are swept in operation 404. If, no transactions remain in the current bucket, process 400 continues to operation 416 where journal sweeping continues to the next bucket until all buckets and/or transactions have been swept.

Note that although process 400 is discussed on a transaction-by-transaction basis, the entire transaction journal may be swept before failures are routed to the correction journal. In some instances, a group of transactions may be routed at given time intervals. Still in other instances, all transactions failures in one or more buckets can be routed to the correction journal simultaneously. In addition, multiple buckets can be swept simultaneously by separate post-processing systems (e.g., PAPPS) existent within the same node/cluster.

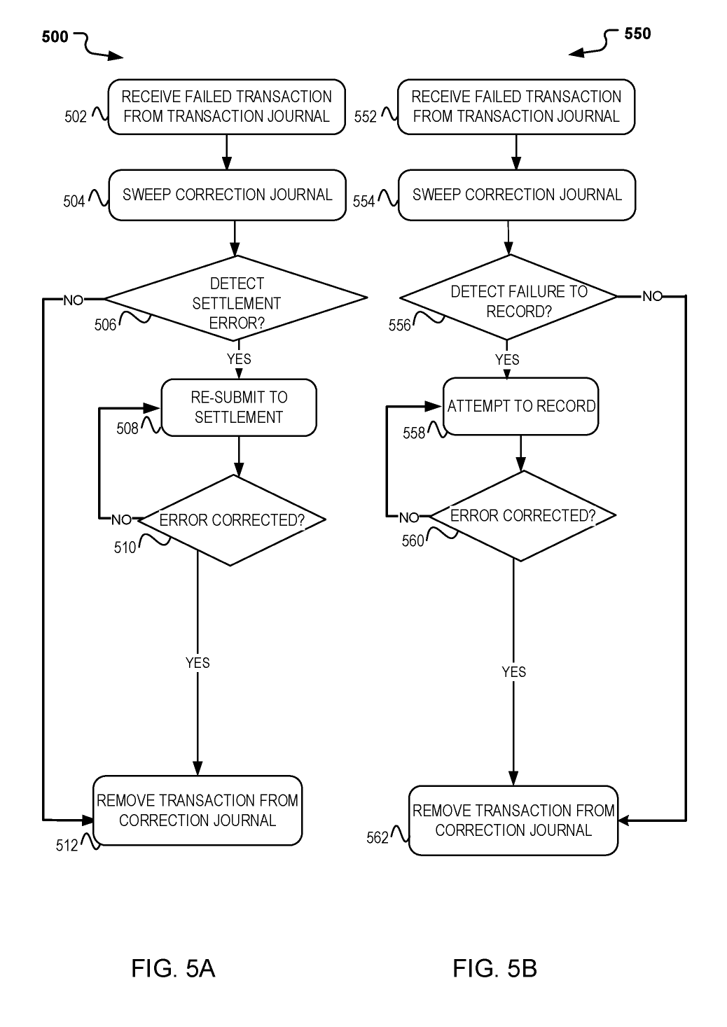

FIGS. 5A-5B illustrate example process 500 and 550 for correction sweeping that may be implemented by a system such as system 100 of FIG. 1 and/or timing diagram 300 of FIG. 3. In particular, FIG. 5A illustrates a flow diagram illustrating operations for correction sweeping in a PAPPS system with settlement errors and FIG. 5B illustrates a flow diagram illustrating operations for correction sweeping in a PAPPS system with failure to record error.

In FIG. 5A, according to some embodiments, process 500 may include one or more of operations 502-512, which may be implemented, at least in part, in the form of executable code stored on a non-transitory, tangible, machine readable media that, when run on one or more hardware processors, may cause a system to perform one or more of the operations 502-512.

Process 500 may begin with operation 502, where a correction journal receives failed transactions or transaction records that were identified during the journal sweeping, as described above and in conjunction with FIG. 4. During this operation, the failed transactions can be recorded in a corrections journal. By recording the failed transactions, those transactions with failures identified can be submitted for correction.

In process 500, once the transactions have been received and recorded in the correction journal, the correction journal gets swept in operation 504. In particular, in operation 504, the correction sweeping process can begin with a scheduler running at a reconfigurable time interval. As previously indicated, in some embodiments, the correction journal can be swept continuously as the transactions with failures arrive for correction. In other embodiments, the correction journal can be swept at time intervals. In a current embodiment, the correction journal is swept at one or more, greater time intervals than the transaction journal. For example, if the transaction journal was swept once an hour then the correction journal can run an hour after the transaction journal has been swept so that those transactions identified for correction from the previous bucket can be swept for correction the following hour. Note that the correction journal sweeping intervals can vary for any time interval and the times provided are for exemplary purposes only. As the correction sweeping begins, operation 504 also selects a bucket ID from available buckets and the corresponding bucket ID is locked. Therefore, the operation of sweeping the correction journal can occur on the selected bucket.

Generally post-processing failures entail settlement errors or failure to record errors. In FIG. 5A, process 500 illustrates the processing of correcting a settlement error at operation 506, while a failure to record occurs at FIG. 5B at operation 556. Note that, in a current embodiment, these two errors are isolated and are recorded in two distinct journals and/or the journal transactions can exist in distinct buckets and have distinct corresponding bucket IDs. Therefore, operations although the process is the same for error correction, FIGS. 5A and 5B provide distinct and separate from operations 502-512 and 552-562, respectively.

In a first flow, process 500 continues with detection of settlement errors, however, other processing errors (pre and/or post-processing) may occur and process 500 is not so limited. In operation 506, after correction journal has been swept, a decision is made to determine whether the current transaction failure is a settlement error. If the determination is made that a settlement error is detected, then operation 500 continues to the re-submission of the transaction to settlement in operation 508 and then further checked to ensure the settlement error was corrected in operation 510. If the settlement error persist, the system in process 500 may continue to attempt to correct the failure until the error is corrected. Alternatively, the system continues to attempt to correct for a given number of times. If the error continues after the given number of attempts have been made, the process can continue with directing the error for manual correction to an operator (not shown). The given number of times may be pre-defined or dynamically determined based on the error type. For example, the system may attempt to correct 3 times. If the settlement error is corrected then the process moves forward to operation 512 for removal or update from the correction journal.

In FIG. 5B, like FIG. 5A, the failure transaction is received at operation 552, and correction sweeping begins at operation 504 with operation 504 including the selection and locking of a bucket ID. Next, in this exemplary diagram, at operation 556, a determination is made if a failure to record error exists. In one embodiment, the failure to record is journaled in a separate journal from the settlement error. Therefore, the failure to record and settlement error can be isolated operations that can be completed independently.

Returning, to process 500, if a settlement error is not detected in operation 556, process 550 continues to operation 562. At operation 556, as indicated, a determination is made as to whether a failure to record has been detected. In this instance, a failure to record can include an indication that the transaction was not properly journaled in a database at the cluster. If a failure to record error is not detected, then the transaction continues to operation 562 where the transaction may be removed or updated from the correction journal.

Alternatively, if a failure is detected then the process 550 continues to attempt to record the transaction at operation 558. At this operation, similar to a failed settlement error, an attempt to correct the error will be made and checked to ensure the error was corrected. In particular, once an attempt to record is performed at operation 558, then operation 560 determines if the transaction was recorded. If a failure to record continues to be detected, then the transaction is once again process for recordation. That is to say, another attempt to record is performed at operation 558. Note that these attempts can continue for a pre-determined number of times and then the option exists to route the failed transaction for manual correction (not shown). Alternatively, if the transaction is recorded, operation 560 continues to operation 562 where the correction is updated or removed from the correction journal. Further, once the transaction is corrected, the correction journal (as indicated above and in conjunction with FIG. 2) may also be updated to reflect the correction.

Note that processes 500 and 550 may include more or less operations. Operations 502-512 and 552-562 are for exemplary purposes and the order and number of operations may be modified. For example, a failure to record error may be detected prior to a failure to settle error. In another example, additional errors are detected and corrected. Still as another example, the settlement error and a failure to record error are independently corrected in distinct journals.

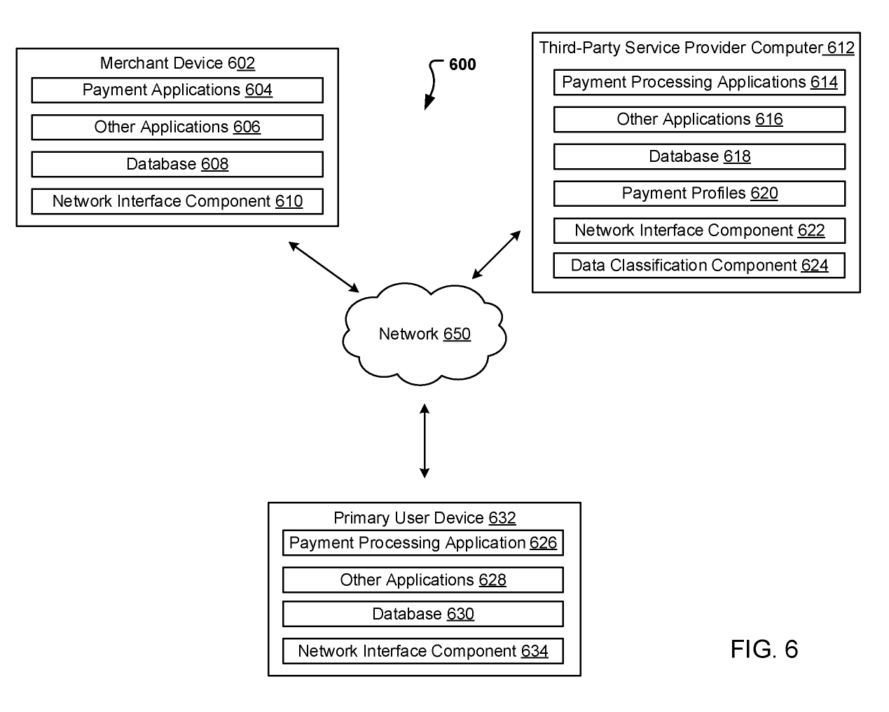

FIG. 6 is a block diagram of a networked system 600 for implementing the processes described herein, according to an embodiment. In particular, FIG. 6 illustrates a block diagram of a system 600 for classifying and correcting failed transactions. As shown, system 600 may include or implement a plurality of devices, computers, servers, and/or software components that operate to perform various methodologies in accordance with the described embodiments. It will be appreciated that the devices, computers, and/or servers illustrated in FIG. 6 may be deployed differently and that the operations performed and/or the services provided by such devices, computers, and/or servers may be combined or separated for a given embodiment and may be performed by a greater number or fewer number of devices, computers, and/or servers. Furthermore, one or more of the devices, computers, and/or servers may be operated and/or maintained by the same or different entities.

System 600 includes a merchant/vendor device 602, a primary user device 632, a third-party service provider computer 612 in communication over a network 650. These devices 602, 632, and 612 are exemplary devices that may interact during a transaction that may result in a failure and would necessitate the need for journaling and correction sweeping.

The merchant device 602, primary user device 632, and the third-party service provider computer 612 may each include one or more processors, memories, and other appropriate components for executing computer-executable instructions such as program code and/or data. The computer-executable instructions may be stored on one or more computer readable mediums or computer readable devices to implement the various applications, data, and steps described herein. For example, such instructions may be stored in one or more computer readable media such as memories or data storage devices internal and/or external to various components of system 600, and/or accessible over network 650.

The merchant device 602 may be implemented as a communication device that may utilize appropriate hardware and software configured for wired and/or wireless communication with the primary user device 632 and third-party service provider computer 612. For example, the merchant device 602 may be implemented as a personal computer (PC), a smart phone, laptop/tablet computer, point-of-sale device, wristwatch with appropriate computer hardware resources, eyeglasses with appropriate computer hardware, other type of wearable computing device, implantable communication devices, servers, and/or other types of computing devices capable of transmitting and/or receiving data. The merchant device 602 may correspond to and be utilized by a user, such as an employee of a merchant and/or another person authorized by the merchant, or independently as a stand-alone system.

The merchant device 602 may include one or more payment applications 604, other applications 606, a database 608, and a network interface component 610. The payment applications 604 and other applications 606 may correspond to executable processes, procedures, and/or applications with associated hardware. In other embodiments, merchant device 602 may include additional or different components having specialized hardware and/or software to perform operations associated with the payment applications 604 and/or the other applications 606.

The payment application 604 may facilitate financial transactions corresponding to the sale of goods and/or services offered by the merchant. For example, the payment application 604 may provide an interface for customers to purchase the goods or services and to receive customer payment information (e.g., customer credit card information). The payment application 604 may further transmit customer payment information to a payment processor (e.g., such as a payment processor corresponding to the third-party service provider computer 612) to process the customer payment information. The payment application 604 may also facilitate other types of financial transactions such as banking, online payments, money transfer, and/or the like.

The merchant device 602 may execute the other applications 606 to perform various other tasks and/or operations corresponding to the merchant device 602. For example, the other applications 606 may include security applications for implementing client-side security features, programmatic client applications for interfacing with appropriate application programming interfaces (APIs) over network 650, or other types of applications. In various embodiments, the other applications 606 may include social networking applications. Additionally, the other applications 606 may include device interfaces and other display modules that may receive input and/or output information. For example, the other applications 606 may include a graphical user interface (GUI) configured to provide an interface to the user.

The merchant device 602 may further include a database 608, which may be stored in a memory and/or other storage device of the merchant device 602. The database 608 may include, for example, identifiers (IDs) such as operating system registry entries, cookies associated with the payment application 604 and/or other applications 606, IDs associated with hardware of the network interface component 610, IDs used for payment/user/device authentication or identification, and/or other appropriate IDs. The database 608 may also include information corresponding to one or purchase transactions of customers who have purchased goods or services from the merchant, browsing histories of the customers, or other types of customer information. In certain embodiments, the merchant device 602 may also include information corresponding to payment tokens, such as payment tokens generated by the third-party service provider computer 612.

The merchant device 602 may also include at least one network interface component 610 configured to communicate with various other devices such as the primary user device 132, and/or the third-party service provider computer 612. In various embodiments, network interface component 610 may include a Digital Subscriber Line (DSL) modem, a Public Switched Telephone Network (PTSN) modem, an Ethernet device, a broadband device, a satellite device and/or various other types of wired and/or wireless network communication devices including microwave, radio frequency, infrared, Bluetooth®, Bluetooth low-energy, near field communication (NFC) devices, and/or the like.

The third-party service provider computer 612 may be maintained, for example, by a third-party service provider, which may provide payment processing services for the merchant. In one example, the third-party service provider may be provided by PAYPAL™ Inc. of San Jose, Calif., USA. Alternatively, the third-party service provider computer 612 may be associated with a user of the primary device 632. As such, the third-party service provider computer 612 includes one or more payment processing applications 614, which may be configured to process payment information received from the merchant device 602 or from a selection at the primary user device 632. In addition, the payment processing services can be tied to a processing system like PAPPS 106 which can aid in transaction post-processing. For example, the payment application 604 of the merchant device 602 may receive payment information from a customer to purchase a service or good offered by the merchant. Upon receipt of the payment information, the payment application 604 may transmit the payment information to the third-party service provider computer 612. The payment processing application 614 of the third-party service provider computer 612 may receive and process the payment information. As another example, the payment application 604 can present a payment code on a display of the user device associated with the merchant. The payment code can be scanned or transmitted to the merchant device 602 for payment processing. Still as another example, the payment processing application can present a successful transaction notification on the display of the user device when the application has been authorized and ready for post-processing.

The third-party service provider computer 612 may execute the other applications 616 to perform various other tasks and/or operations corresponding to the third-party service provider computer 612. For example, the other applications 616 may include security applications for implementing client-side security features, programmatic client applications for interfacing with appropriate APIs over the network 650, or other types of applications. The other applications 616 may also include additional communication applications, such as email, texting, voice, and IM applications that enable communication of emails, calls, texts, and other notifications through the network 650. In various embodiments, the other applications 616 may include location detection applications, such as a mapping, compass, and/or GPS applications, which may be used to determine a location of the third-party service provider computer 612. Additionally, the other applications 616 may include device interfaces and other display modules that may receive input and/or output information. For example, the other applications 616 may include a GUI configured to provide an interface to one or more users.

The third-party service provider computer 612 may further include a database 618, which may be stored in a memory and/or other storage device of the third-party service provider computer 612. The database 618 may include, for example, IDs such as operating system registry entries, cookies associated with the payment processing application 614 and/or other the applications 616, IDs associated with hardware of the network interface component 622, IDs used for payment/user/device authentication or identification, transaction IDs, and/or other appropriate IDs.

According to a particular embodiment, the third-party service provider computer 612 may include a set of payment profiles 620 corresponding to past sales transactions executed by the merchant device 102 with respect to one or more customers of the merchant. Alternatively, the third-party service provider computer 612 may include a set of merchant payment profiles corresponding to the payment sources associated to a corresponding merchant. For example, a particular payment profile from the set of payment profiles 620 may include payment information corresponding to a particular customer of the merchant and/or a merchant associated with a user. The payment information may include credit card information (e.g., encrypted card number, expiration date, security code, card issuer, and/or the like), Automated Clearing House (ACH) information (e.g., encrypted account number, routing number, and/or the like), identification information associated with the particular customer/user (e.g., a customer identifier, name, address, phone number, date of birth, and/or the like), billing information, credit score, and/or any other type of payment information associated with the particular customer. Furthermore, other payment profiles of the set of payment profiles 620 may include payment information corresponding to other customers of the merchant and/or other merchants associated with the user. In addition, the third-party service provider computer 612 may store the set of payment profiles 620 according to a first file format.

The third-party service provider computer 612 may also store a set of payment tokens corresponding to the set of payment profiles 620. For example, each payment profile of the set of payment profiles 620 may be associated with a corresponding payment token from the set of payment tokens. In some embodiments, each payment profile may include a corresponding payment token from the set of payment tokens. The set of payment tokens may be particular to the third-party service provider computer 612 (e.g., computers from other service providers may be unable to use the set of payment tokens) and may enable the merchant device 602 to more securely process payment transactions with the third-party service provider computer 612. For example, in order to process a payment transaction that involves a credit card number associated with a particular payment profile, the third-party service provider computer 612 may provide the merchant device 602 with a particular payment token that is different from the credit card number. The merchant device 602 may use the particular payment token to process the payment transaction instead of the credit card number. Further, the merchant device may store and associate the particular payment token with the particular payment profile instead of the credit card number, thereby protecting the credit card number from being stolen in a potential security breach of the merchant device 602.

In various embodiments, the third-party service provider computer 612 also includes at least one network interface component 622 that is configured to communicate with the merchant device 602, the primary user device 632, and/or the secondary user device 636 via the network 650.

The third party provider computer 612, may also include a data classification component 624 that may be used for raw data classification. In one embodiment, the raw data received by the third-party service provider computer 612 and/or stored in database 618 can be analyzed to identify errors in transaction post-processing. Additionally or alternatively, database 618 and/or classification component 624 may be communicatively coupled to PAPPS 106 for transaction record journaling, error detection, and error correction of transactions performed via the merchant device 602 and/or primary user device 632.

The primary user device 632 may be implemented as a communication device that may utilize appropriate hardware and software configured for wired and/or wireless communication with the merchant device 602 and third-party service provider computer 612. The primary user device 632, may be a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data. In one embodiment, the primary user device 632 may be mobile device communicating with wearable device (or secondary user device), merchant device 602, or directly with the third-party service provider system 612.

The primary user device 632 may include a payment processing application 626 that may be used as a digital wallet that can communicate with a merchant device 602, a secondary user device, and/or third party service provider 612 for purchasing and transacting. The payment processing application 626, can work jointly with database 630 for retrieving bank account information, user accounts, security codes, tokens that may be associated with various merchant locations. Similarly, the payment processing application, can also provide access the user profiles for determining which payment method, processing code, to use at a merchant location.

The primary user device 632 may also include other applications 628 to perform various other tasks and/or operations corresponding to the primary user device 632. For example, the other applications 628 may facilitate communication with the merchant device 602, such as to receive an indication, from the merchant device 602, to switch payment processing services from the third-party service provider to the service provider. As another example, the other applications 628 may include security applications, application that enable designation of a primary interactive device, and applications that allow for web site searches (including access to merchant websites). The other applications 628 may also include additional communication applications, such as email, texting, voice, and IM applications that enable communication of emails, calls, texts, and other notifications through the network 650. In various embodiments, the other applications 628 may include location detection applications, such as a mapping, compass, and/or GPS applications, which may be used to determine a location of the primary user device 632. The other applications 628 may include social networking applications. Additionally, the other applications 628 may include device interfaces and other display modules that may receive input and/or output information. For example, the other applications 628 may include a GUI configured to provide an interface to one or more users.

The primary user device 632 may further include a database 630, which may be stored in a memory and/or other storage device of the primary user device 632. The database 630 may include, for example, identifiers (IDs) such as operating system registry entries, cookies associated with a web browser and/or the other applications 628, IDs associated with hardware of the network interface component 634, IDs used for payment/user/device authentication or identification, bank information, merchant information, user accounts, and/or other appropriate IDs.

The primary user device 632 may also include at least one network interface component 634 configured to communicate with various other devices such as the merchant device 602 and/or the third-party service provider computer 612.

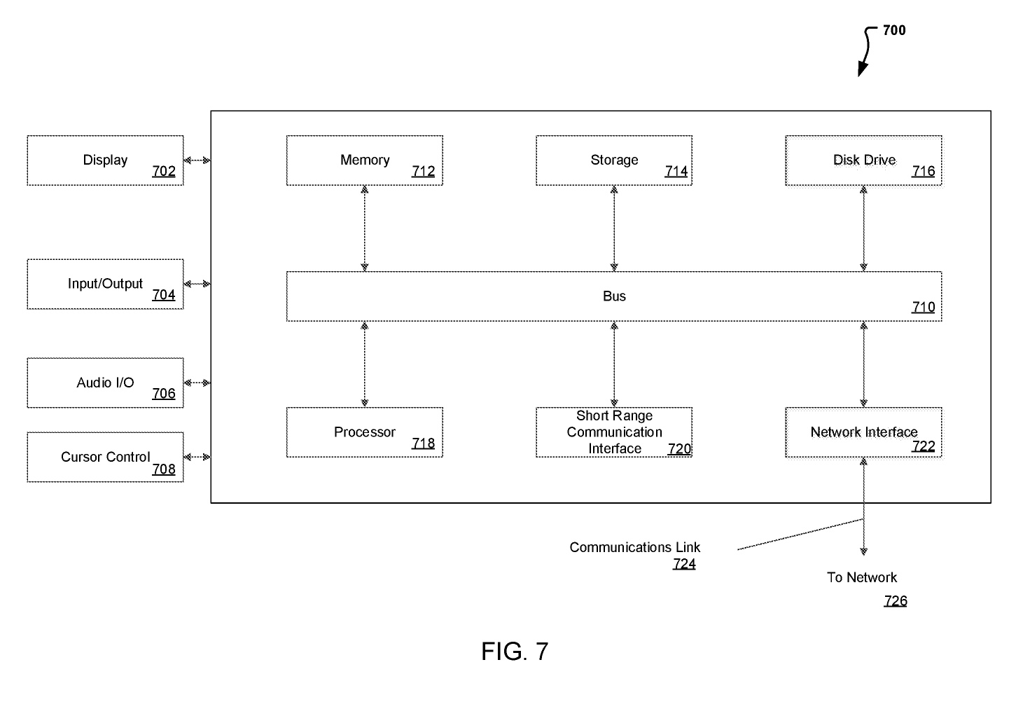

FIG. 7 illustrates an example computer system 700 in block diagram format suitable for implementing on one or more devices of the system in FIG. 1. In various implementations, a device that includes computer system 700 may comprise a computing device (e.g., a smart or mobile device, a computing tablet, a personal computer, laptop, wearable device, PDA, server, etc.) that is capable of communicating with a network 726. A service provider and/or a content provider may utilize a network computing device (e.g., a network server or third-party service provider computer 612) capable of communicating with the network 726. It should be appreciated that each of the devices utilized by users, service providers, and content providers may be implemented as computer system 700 in a manner as follows.

Additionally, as more and more devices become communication capable, such as new smart devices using wireless communication to report, track, message, relay information and so forth, these devices may be part of computer system 700. For example, windows, walls, and other objects may double as touch screen devices for users to interact with. Such devices may be incorporated with the systems discussed herein.

Computer system 700 may include a bus 710 or other communication mechanisms for communicating information data, signals, and information between various components of computer system 700. Components include an input/output (I/O) component 704 that processes a user action, such as selecting keys from a keypad/keyboard, selecting one or more buttons, links, actuatable elements, etc., and sending a corresponding signal to bus 710. I/O component 704 may also include an output component, such as a display 702 and a cursor control 708 (such as a keyboard, keypad, mouse, touchscreen, etc.). In some examples, I/O component 704 may include an image sensor for capturing images and/or video, such as a complementary metal oxide semiconductor (CMOS) image sensor, and/or the like. An audio input/output component 706 may also be included to allow a user to use voice for inputting information by converting audio signals. Audio I/O component 706 may allow the user to hear audio. A transceiver or network interface 722 transmits and receives signals between computer system 600 and other devices, such as another user device, a merchant server, an email server, application service provider, web server, a payment provider server, and/or other servers via a network. In various embodiments, such as for many cellular telephone and other mobile device embodiments, this transmission may be wireless, although other transmission mediums and methods may also be suitable. A processor 718, which may be a micro-controller, digital signal processor (DSP), or other processing component, that processes these various signals, such as for display on computer system 700 or transmission to other devices over a network 726 via a communication link 724. Again, communication link 724 may be a wireless communication in some embodiments. Processor 718 may also control transmission of information, such as cookies, IP addresses, images, and/or the like to other devices.

Components of computer system 700 also include a system memory component 714 (e.g., RAM), a static storage component 714 (e.g., ROM), and/or a disk drive 716. Computer system 700 performs specific operations by processor 718 and other components by executing one or more sequences of instructions contained in system memory component 712. Logic may be encoded in a computer readable medium, which may refer to any medium that participates in providing instructions to processor 718 for execution. Such a medium may take many forms, including but not limited to, non-volatile media, volatile media, and/or transmission media. In various implementations, non-volatile media includes optical or magnetic disks, volatile media includes dynamic memory such as system memory component 712, and transmission media includes coaxial cables, copper wire, and fiber optics, including wires that comprise bus 710. In one embodiment, the logic is encoded in a non-transitory machine-readable medium. In one example, transmission media may take the form of acoustic or light waves, such as those generated during radio wave, optical, and infrared data communications.

Some common forms of computer readable media include, for example, hard disk, magnetic tape, any other magnetic medium, CD-ROM, any other optical medium, RAM, PROM, EPROM, FLASH-EPROM, any other memory chip or cartridge, or any other medium from which a computer is adapted to read.

Components of computer system 700 may also include a short range communications interface 720. Short range communications interface 720, in various embodiments, may include transceiver circuitry, an antenna, and/or waveguide. Short range communications interface 720 may use one or more short-range wireless communication technologies, protocols, and/or standards (e.g., WiFi, Bluetooth®, Bluetooth Low Energy (BLE), infrared, NFC, etc.).

Short range communications interface 720, in various embodiments, may be configured to detect other devices (e.g., primary user device 632, merchant device 602, etc.) with short range communications technology near computer system 700. Short range communications interface 720 may create a communication area for detecting other devices with short range communication capabilities. When other devices with short range communications capabilities are placed in the communication area of short range communications interface 720, short range communications interface 720 may detect the other devices and exchange data with the other devices. Short range communications interface 720 may receive identifier data packets from the other devices when in sufficiently close proximity. The identifier data packets may include one or more identifiers, which may be operating system registry entries, cookies associated with an application, identifiers associated with hardware of the other device, and/or various other appropriate identifiers.

In some embodiments, short range communications interface 720 may identify a local area network using a short range communications protocol, such as WiFi, and join the local area network. In some examples, computer system 700 may discover and/or communicate with other devices that are a part of the local area network using short range communications interface 720. In some embodiments, short range communications interface 720 may further exchange data and information with the other devices that are communicatively coupled with short range communications interface 720.

In various embodiments of the present disclosure, execution of instruction sequences to practice the present disclosure may be performed by computer system 700. In various other embodiments of the present disclosure, a plurality of computer systems 700 coupled by communication link 724 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein may be embodied in one or more computer readable media or be in communication with one or more processors to execute or process the techniques and algorithms described herein.

A computer system may transmit and receive messages, data, information and instructions, including one or more programs (i.e., application code) through a communication link 724 and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable media. It is also contemplated that software identified herein may be implemented using one or more computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants/vendors and customers; however, a customer or consumer can pay, or otherwise interact with any type of recipient, including charities and individuals. Thus, “merchant” as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory storing instructions;
a processor configured to execute the instructions to cause the system to:
access, transaction records from a journaling sub-system, the transaction records corresponding to transactions processed by a payment application system;
categorize, by a journaling execution sub-system, the transaction records into one of a plurality of buckets;
sweep, by a transaction journaling sub-system, a first bucket in the plurality of buckets, the first bucket including a first set of transaction records from the transaction records categorized;
correct, by a correction journaling sub-system, a first post-processing failure identified in a first transaction record during the sweep of the first bucket;
in response to correcting the first post-processing failure identified, update, in the transaction journaling sub-system, the first transaction record corresponding to the first post-processing failure identified; and
correct, by the correction journaling sub-system, a second post-processing failure identified in a second transaction record during the sweep of the first bucket.

2. The system of claim 1, wherein the system includes a payment application and post-processing system.

3. The system of claim 1, wherein the transaction journaling sub-system selects and locks a bucket range used in a categorizing of the transaction records.

4. The system of claim 1, executing the instructions further causes the system to: in response to correcting the second post-processing failure identified, update, in the transaction journaling sub-system, the second transaction record corresponding to the first post-processing failure identified, and wherein the system continues to correct other post-processing failures during the sweep of the first bucket.

5. The system of claim 1, wherein the first post-processing failure is one of a settlement error and a failure to record error.

6. The system of claim 1, wherein the correction journaling sub-system attempts to correct the first post-processing failure a predetermined number of times.

7. The system of claim 1, executing the instructions further causes the system to: sweep, by a transaction journaling sub-system, a second bucket in the plurality of buckets, the second bucket including a second set of transaction records from the transaction records categorized, and wherein the second bucket is swept after the first set of transaction record are swept by the correction journaling sub-system.

8. A method, comprising:
accessing, transaction records from a journaling sub-system, the transaction records corresponding to transactions processed by a payment application system;
categorizing, by a journaling execution sub-system, the transaction records into one of a plurality of buckets;
sweeping, by a transaction journaling sub-system, a first bucket in the plurality of buckets, the first bucket including a first set of transaction records from the transaction records categorized;
correcting, by a correction journaling sub-system, a first post-processing failure identified in a first transaction record during the sweep of the first bucket;
in response to the correcting of the first post-processing failure identified, updating, in the transaction journaling sub-system, the first transaction record corresponding to the first post-processing failure identified; and
correcting, by the correction journaling sub-system, a second post-processing failure identified in a second transaction record during the sweep of the first bucket.

9. The method of claim 8, wherein the system includes a payment application and post-processing system.

10. The method of claim 8, wherein the transaction journaling sub-system selects and locks a bucket range used in a categorizing of the transaction records.

11. The method of claim 8, further comprising:
in response to the correcting of the second post-processing failure identified, updating, in the transaction journaling sub-system, the second transaction record corresponding to the first post-processing failure identified, and wherein the system continues to correct other post-processing failures during the sweep of the first bucket.

12. The method of claim 8, wherein the first post-processing failure is one of a settlement error and a failure to record error.

13. The method of claim 8, wherein the correction journaling sub-system attempts to correct the first post-processing failure a predetermined number of times.

14. The method of claim 8, further comprising:
sweeping, by a transaction journaling sub-system, a second bucket in the plurality of buckets, the second bucket including a second set of transaction records from the transaction records categorized, and wherein the second bucket is swept after the first set of transaction record are swept by the correction journaling sub-system.

15. A non-transitory machine-readable medium having instructions stored thereon, the instructions executable to cause performance of operations comprising:
accessing, transaction records from a journaling sub-system, the transaction records corresponding to transactions processed by a payment application system;
categorizing, by a journaling execution sub-system, the transaction records into one of a plurality of buckets;
sweeping, by a transaction journaling sub-system, a first bucket in the plurality of buckets, the first bucket including a first set of transaction records from the transaction records categorized;
correcting, by a correction journaling sub-system, a first post-processing failure identified in a first transaction record during the sweep of the first bucket;
in response to the correcting of the first post-processing failure identified, updating, in the transaction journaling sub-system, the first transaction record corresponding to the first post-processing failure identified; and
correcting, by the correction journaling sub-system, a second post-processing failure identified in a second transaction record during the sweep of the first bucket.

16. The non-transitory machine-readable medium of claim 15, wherein the system includes a payment application and post-processing system.

17. The non-transitory machine-readable medium of claim 15, wherein the transaction journaling sub-system selects and locks a bucket range used in a categorizing of the transaction records.

18. The non-transitory machine-readable medium of claim 15, further comprising:
in response to the correcting of the second post-processing failure identified, updating, in the transaction journaling sub-system, the second transaction record corresponding to the first post-processing failure identified, and wherein the system continues to correct other post-processing failures during the sweep of the first bucket.

19. The non-transitory machine-readable medium of claim 15, wherein the first post-processing failure is one of a settlement error and a failure to record error.

20. The non-transitory machine-readable medium of claim 15, wherein the correction journaling sub-system attempts to correct the first post-processing failure a predetermined number of times.
